(19) United States
(12) Patent Application Publication
(10) Pub. No.: US 2026/0060167 A1
(43) Pub. Date: Mar. 5, 2026

(54) SWING DISC SPREADER, SPREADING DEVICE AND UNMANNED AERIAL VEHICLE

(71) Applicant: GUANGZHOU XAIRCRAFT TECHNOLOGY CO., LTD., Guangzhou (CN)

(72) Inventors: Bin PENG, Guangzhou (CN); Zuojun DING, Guangzhou (CN); Haijun WEN, Guangzhou (CN)

(73) Assignee: GUANGZHOU XAIRCRAFT TECHNOLOGY CO., LTD., Guangzhou (CN)

(21) Appl. No.: 19/381,874

(22) Filed: Nov. 6, 2025

Related U.S. Application Data
(63) Continuation of application No. PCT/CN2024/101914, filed on Jun. 27, 2024.

(30) Foreign Application Priority Data
Jun. 30, 2023 (CN) 202310802257.8
Jun. 30, 2023 (CN) 202310802613.6
Jun. 30, 2023 (CN) 202321713356.0
Jun. 30, 2023 (CN) 202321714304.5
Nov. 3, 2023 (CN) 202311465760.5
Nov. 3, 2023 (CN) 202311465799.7

(51) Int. Cl. A01C 17/00; A01C 15/00

(52) U.S. Cl. CPC A01C 17/003; A01C 15/007; A01C 17/005

(57) ABSTRACT

A swing disc spreader includes a swing disc which is arranged to be rotatable; and a swing driving mechanism, which is in transmission connection to the swing disc and used for driving the swing disc to swing reciprocatingly, the swing disc being configured to be in contact with materials during a swinging process so as to spread the materials outwards. In the technical solution provided in the present application, the swing disc spreader can achieve the spreading operation of materials simply by using one swing disc, such that the swing disc spreader has a simpler structure, achieves a reduced overall size and a relatively uniform spreading width, thus reducing the cost.

### CROSS-REFERENCE TO RELATED APPLICATIONS

This application is a continuation of International Application No. PCT/CN2024/101914, filed on Jun. 27, 2024, which claims priorities to Chinese Patent Application No. 202311465799.7, filed on Nov. 3, 2023, Chinese Patent Application No. 202311465760.5, filed on Nov. 3, 2023, Chinese Patent Application No. 202310802257.8, filed on Jun. 30, 2023, Chinese Patent Application No. 202310802613.6, filed on Jun. 30, 2023, Chinese Patent Application No. 202321713356.0, filed on Jun. 30, 2023, and Chinese Patent Application No. 202321714304.5, filed on Jun. 30, 2023. All of the aforementioned applications are incorporated herein by reference in their entireties.

### TECHNICAL FIELD

The present disclosure relates to the field of spreading technology, in particular to a swing disc spreader, a spreading device and an unmanned aerial vehicle.

### BACKGROUND

Agricultural unmanned aerial vehicles have developed rapidly, and their payload increases gradually, so they have been applied to field agricultural production. For the management of field crops, the unmanned aerial vehicle is used to not only spray liquid farm chemicals, but also spread particles such as seeds, powders and solid fertilizers.

In order to spread the particles such as seeds, powders and solid fertilizers, the unmanned aerial vehicle is equipped with a spreading device. A spreading assembly needs to be provided with a large sowing width to reduce a flight frequency, and an existing spreading device is provided with two spreading assemblies arranged side by side. However, this spreading device has a complex structure, a large volume and a high cost.

### SUMMARY

An object of the present disclosure is to provide a swing disc spreader, a spreading device and an unmanned aerial vehicle, so as to solve the problems in the related art where the spreading device has a complex structure, a large volume and a high cost.

In a first aspect, the present disclosure provides in some embodiments a swing disc spreader, including: a rotatable swing disc; and a swinging drive mechanism in transmission connection with the swing disc and configured to drive the swing disc to swing back and forth. The swing disc is in contact with a material during the swinging to spread the material to the outside.

According to the embodiments of the present disclosure, during the operation of the swing disc spreader, the swinging drive mechanism drives the swing disc to swing back and forth, and the swing disc is in contact with the material during the swinging to spread the material to the outside. As compared with the related art where two spreading assemblies are arranged side by side, in the embodiments of the present disclosure, the swing disc spreader spreads the material through merely one swing disc, so it is able to simplify the structure, reduce the overall volume, provide a uniform sowing width, and reduce the cost.

In a possible embodiment of the present disclosure, the swing disc spreader further includes an installation housing, the installation housing is provided with a material inlet and a material outlet, and the swing disc is rotatably mounted inside the installation housing. The material entering the installation housing via the material inlet is spread to the outside via the material outlet in a case that the swing disc swings.

In a possible embodiment of the present disclosure, the swinging drive mechanism includes a first electric motor and a connection rod mechanism, the first electric motor is configured to drive the connection rod mechanism to move, and the connection rod mechanism is configured to drive the swing disc to swing.

In a possible embodiment of the present disclosure, the connection rod mechanism is arranged outside the installation housing, and the connection rod mechanism is connected to the swing disc via an installation hole in the installation housing.

In a possible embodiment of the present disclosure, the installation housing includes a first housing and a second housing, and the first housing is fastened to the second housing to form an accommodation space for receiving the swing disc; and the first housing is provided with the material inlet, the swing disc is mounted on the second housing, and the connection rod mechanism is mounted on a side of the second housing away from the swing disc.

In a possible embodiment of the present disclosure, the connection rod mechanism includes a first connection rod, a second connection rod and an intermediate connection rod; and the first connection rod is configured to rotate under the effect of the first electric motor, the second connection rod is connected to the swing disc and limited relative to the swing disc in a circumferential direction, one end of the intermediate connection rod is rotatably connected to the first connection rod, another end of the intermediate connection rod is rotatably connected to the second connection rod, and the first connection rod rotates to drive the second connection rod to swing through the intermediate connection rod, so that the second connection rod drives the swing disc to swing back and forth.

In a possible embodiment of the present disclosure, the connection rod mechanism is arranged outside the installation housing; and the swing disc is provided with a non-circular hole at a side facing the connection rod mechanism, the second connection rod is provided with a connection shaft, the connection shaft includes a non-circular member passing through the installation housing and fitted into the non-circular hole, and the second connection rod drives the swing disc to swing through the non-circular member.

In a possible embodiment of the present disclosure, the first connection rod is provided with a balancing weight at an end away from the intermediate connection rod; and/or a rotary shaft of at least one of the first connection rod, the intermediate connection rod and the second connection rod is mounted into a collar, and a cushion is arranged between the rotary shaft and the collar.

In a possible embodiment of the present disclosure, the connection rod mechanism is provided with an electric motor installation seat for the first electric motor at a side away from the installation housing, and the electric motor installation seat is fixed onto the installation housing.

In a possible embodiment of the present disclosure, the swing disc is configured to swing back and forth from one side to another side in a vertical direction, and the swing disc includes a spreading member located below a swinging center of the swing disc.

In a possible embodiment of the present disclosure, the swing disc includes a swing disc body and a spreading member arranged on the swing disc body, the spreading member includes a plurality of blades spaced apart from each other at intervals in a circumferential direction, and a material-passing space is formed between the adjacent blades.

In a possible embodiment of the present disclosure, the swing disc includes a spreading member arranged at one side of a swinging center and a block arranged at another side of the swinging center. The block is a balancing weight; and/or the block is a buffer block colliding with buffer assemblies, and the buffer assemblies are mounted on the installation housing and arranged at two sides of the block.

In a possible embodiment of the present disclosure, the swing disc is rotatable, and a guiding slot is formed in the swing disc; and the swinging drive mechanism includes a rotatable plate and a bump arranged at a position away from a center of the rotatable plate, the bump is located in the guiding slot, and in a case that the rotatable plate rotates, the bump moves in the guiding slot to drive the swing disc to swing with a rotation center as a swinging center.

In a possible embodiment of the present disclosure, the swing disc body is of a fan-shaped structure, and the plurality of blades is arranged along an arc edge of the swing disc body.

In a possible embodiment of the present disclosure, an angle is formed between an extension direction of each blade and a radial direction of the swing disc body, and the angles between different blades and the radial direction are different.

In a possible embodiment of the present disclosure, a swinging plane of the swing disc is perpendicular to a reference plane, and swinging amplitudes of the swing disc at two sides of the reference plane are the same.

In a possible embodiment of the present disclosure, the reference plane is parallel to a vertical direction.

In a second aspect, the present disclosure provides in some embodiments a spreading device, including the above-mentioned swing disc spreader and a feeding mechanism for supplying a material to the swing disc spreader.

In a possible embodiment of the present disclosure, the feeding mechanism includes a main frame with a feeding inlet and a material guiding assembly mounted on the main frame, the material guiding assembly is configured to deliver the material in the main frame to the material inlet of the swing disc spreader, and the material guiding assembly includes an auger and a second electric motor for driving the auger.

In a possible embodiment of the present disclosure, the swing disc spreader is arranged in such a manner that a swinging plane of the swing disc is angled relative to a horizontal plane by 0°to 90°.

In a possible embodiment of the present disclosure, the spreading device further includes a housing, the swing disc is rotatably arranged inside the housing, the feeding mechanism and the swinging drive mechanism are arranged at two sides of the housing respectively, and the feeding mechanism and the swinging drive mechanism are connected to the housing.

In a possible embodiment of the present disclosure, the swinging drive mechanism includes a transmission member connected to the swing disc and configured to drive the swing disc to move; and the spreading device further includes a separator arranged between the swing disc and the transmission member and configured to prevent the material from entering the transmission member.

In a possible embodiment of the present disclosure, the separator includes a baffle, and the swing disc and the transmission member are arranged at two sides of the baffle respectively.

In a possible embodiment of the present disclosure, the baffle is provided with a connection hole, and the transmission member is connected to the swing disc via the connection hole.

In a possible embodiment of the present disclosure, the spreading device includes a sealing element arranged in the connection hole.

In a possible embodiment of the present disclosure, the separator further includes a cover plate arranged at a side of the baffle away from the swing disc and configured to cover the transmission member.

In a possible embodiment of the present disclosure, an annular plate is arranged on the baffle at a side away from the swing disc, the annular plate is detachably connected to the cover plate, an accommodation cavity is defined by the annular plate and the cover plate, and the transmission member is arranged in the accommodation cavity.

In a possible embodiment of the present disclosure, the spreading device further includes a first housing arranged at a side of the separator close to the swing disc and configured to cover the swing disc.

In a possible embodiment of the present disclosure, the first housing includes a side plate and an arc-like plate arranged at a side of the side plate close to the swing disc, the arc-like plate is connected to an upper edge of the side plate and the baffle, the side plate is spaced apart from the baffle through the arc-like plate, and the swing disc is arranged between the side plate and the baffle.

In a possible embodiment of the present disclosure, the spreading device further includes an auger, and one end of the auger is connected to the side plate.

In a possible embodiment of the present disclosure, the side plate is provided with a through-hole, one end of the auger is connected to the through-hole and configured to deliver the material to the through-hole, and the material passes through the through-hole to be in contact with the swing disc so that the material is spread to the outside.

In a third aspect, the present disclosure provides in some embodiments an unmanned aerial vehicle including the above-mentioned spreading device.

In a possible embodiment of the present disclosure, a swinging plane of the swing disc is parallel to a yaw axis or a roll axis of the unmanned aerial vehicle.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort. In the drawings:

FIG. 1 is a schematic view showing a swing disc spreader according to an embodiment of the present disclosure;

FIG. 2 is an exploded view of the swing disc spreader in FIG. 1;

FIG. 3 is another exploded view of the swing disc spreader in FIG. 1;

FIG. 4 is a schematic view showing a swing disc according to an embodiment of the present disclosure;

FIG. 5 is a schematic view showing a buffer assembly according to an embodiment of the present disclosure;

FIG. 6 is a schematic view showing the swing disc and a connection rod mechanism on an installation housing according to an embodiment of the present disclosure;

FIG. 7 is an exploded view of the structure in FIG. 6;

FIG. 8 is a schematic view showing a swinging drive mechanism and an electric motor installation seat according to an embodiment of the present disclosure;

FIG. 9 is a schematic view showing a situation where the swing disc is connected to the swinging drive mechanism according to an embodiment of the present disclosure;

FIG. 10 is a schematic view showing a spreading device according to an embodiment of the present disclosure;

FIG. 11 is a sectional view of the spreading device in FIG. 10 (a swinging plane of the swing disc is a vertical plane);

FIG. 12 is a partially enlarged view of the spreading device in FIG. 11;

FIG. 13 is a sectional view of the spreading device in FIG. 10 (a swinging plane of the swing disc is a horizontal plane);

FIG. 14 is an exploded view of the spreading device in FIG. 9;

FIG. 15 is a schematic view showing the spreading device according to an embodiment of the present disclosure; and

FIG. 16 is another schematic view showing the spreading device according to an embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure. Generally, assemblies in the drawings may be arranged and designed in various configurations.

Hence, the followings are merely the preferred embodiments, but shall not be construed as limiting the scope of the present disclosure. Based on these embodiments, a person skilled in the art may, without any creative effort, obtain the other embodiments, which also fall within the scope of the present disclosure.

In the embodiments of the present disclosure, similar reference numerals and characters represent a similar element. Hence, once one element is defined in one figure, it will not be further defined and interpreted in the subsequent figures.

In the embodiments of the present disclosure, such words as “on/above”, “under/below”, “inside” and “outside” are used to indicate directions or positions as viewed in the drawings or customary directions or positions in use, and they are merely used to facilitate the description in the present disclosure, rather than to indicate or imply that a device or member must be arranged or operated at a specific position.

In addition, such words as “first” and “second” are merely used to differentiate different components rather than to represent any importance.

It should be appreciated that, in the case of no conflict, the features in the embodiments of the present disclosure may be combined in any form.

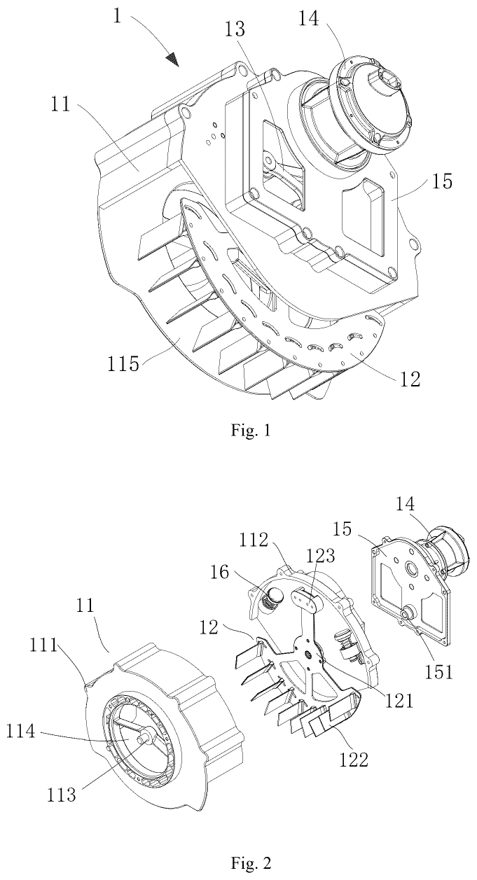

The present disclosure provides in some embodiments a swing disc spreader 1 which, as shown in FIGS. 1 to 3, includes a swing disc 12 and a swinging drive mechanism. The swing disc 12 is rotatable. The swinging drive mechanism is in transmission connection with the swing disc 12, and configured to drive the swing disc 12 to swing back and forth. The swing disc 12 is in contact with a material during the swinging, so as to spread the material to the outside.

According to the embodiments of the present disclosure, during the operation of the swing disc spreader 1, the swinging drive mechanism drives the swing disc 12 to swing back and forth, and during the swinging, the swing disc 12 is in contact with the material so as to spread the material to the outside. As compared with the related art where two spreading assemblies are arranged side by side, in the embodiments of the present disclosure, the swing disc spreader 1 spreads the material through merely one swing disc 12, so it is able to simplify the structure, reduce the overall volume, provide a uniform sowing width, and reduce the cost.

In an embodiment of the present disclosure, the swing disc spreader further includes an installation housing 11, the installation housing 11 is provided with a material inlet 114 and a material outlet 115, and the swing disc 12 is rotatably mounted inside the installation housing 11. The material entering the installation housing 11 via the material inlet 114 is spread to the outside via the material outlet 115 in a case that the swing disc 12 swings.

In an embodiment of the present disclosure, the swinging drive mechanism includes a first electric motor 14 and a transmission member, the first electric motor 14 is configured to drive the transmission member to move, and the transmission member is connected to the swing disc 12 and configured to drive the swing disc 12 to move. In some embodiments of the present disclosure, the transmission member drives the swing disc 12 to swing.

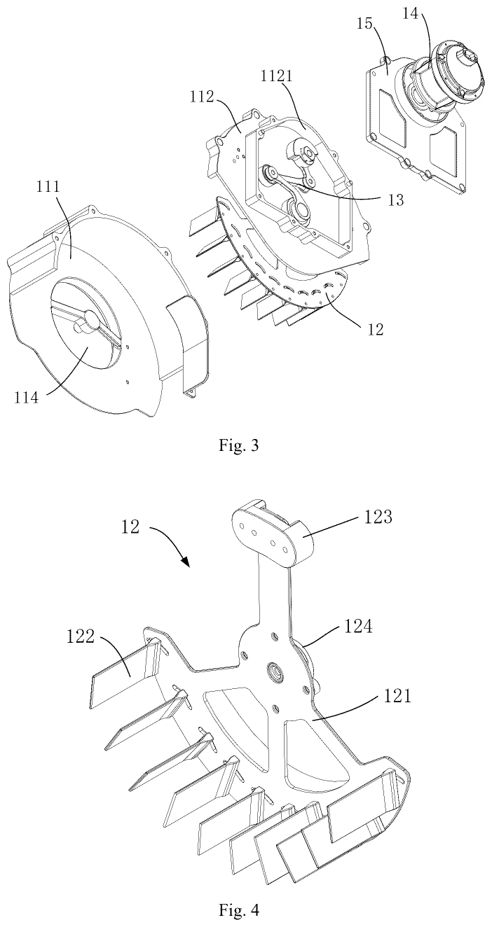

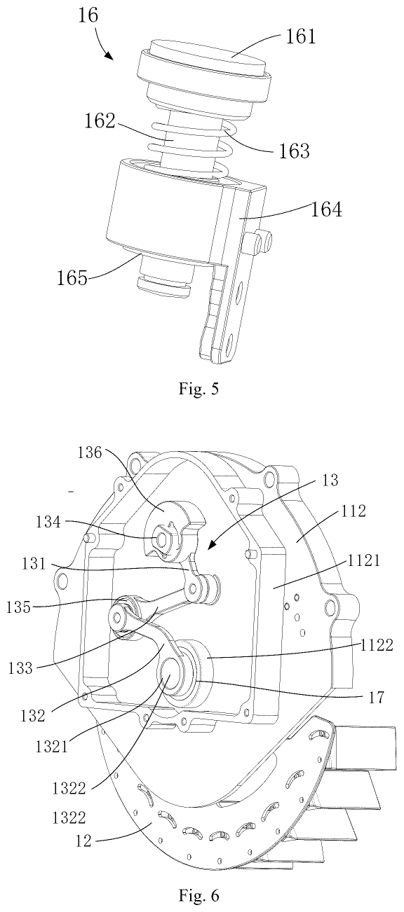

In an embodiment of the present disclosure, as shown in FIGS. 3 and 6, the swinging drive mechanism includes the first electric motor 14 and a connection rod mechanism 13, the first electric motor 14 is configured to drive the connection rod mechanism 13 to move, and the connection rod mechanism 13 is configured to drive the swing disc 12 to swing.

In an embodiment of the present disclosure, the connection rod mechanism 13 is arranged outside the installation housing 11, and the connection rod mechanism 13 is connected to the swing disc 12 via an installation hole in the installation housing 11. The connection rod mechanism 13 includes a first connection rod 131, a second connection rod 132 and an intermediate connection rod 133, and the second connection rod 132 is connected to the swing disc 12 via the installation hole in the installation housing 11.

To be specific, as shown in FIGS. 2 and 3, for ease of assembling, the installation housing 11 includes a first housing 111 and a second housing 112, and the first housing 111 is fastened to the second housing 112 to form an accommodation space for receiving the swing disc 12. The first housing 111 is provided with the material inlet 114, the swing disc 12 is mounted on the second housing 112, and the connection rod mechanism 13 is mounted on a side of the second housing 112 away from the swing disc 12.

In an embodiment of the present disclosure, as shown in FIGS. 6 to 8, the connection rod mechanism 13 includes the first connection rod 131, the second connection rod 132 and the intermediate connection rod 133.

The first connection rod 131 is configured to rotate about a driving shaft 134 under the effect of the first electric motor 14, and the second connection rod 132 is connected to the swing disc 12 and limited relative to the swing disc 12 in a circumferential direction. One end of the intermediate connection rod 133 is rotatably connected to the first connection rod 131, another end of the intermediate connection rod 133 is rotatably connected to the second connection rod 132, and the first connection rod 131 rotates to drive the second connection rod 132 to swing through the intermediate connection rod 133, so that the second connection rod 132 drives the swing disc 12 to swing back and forth.

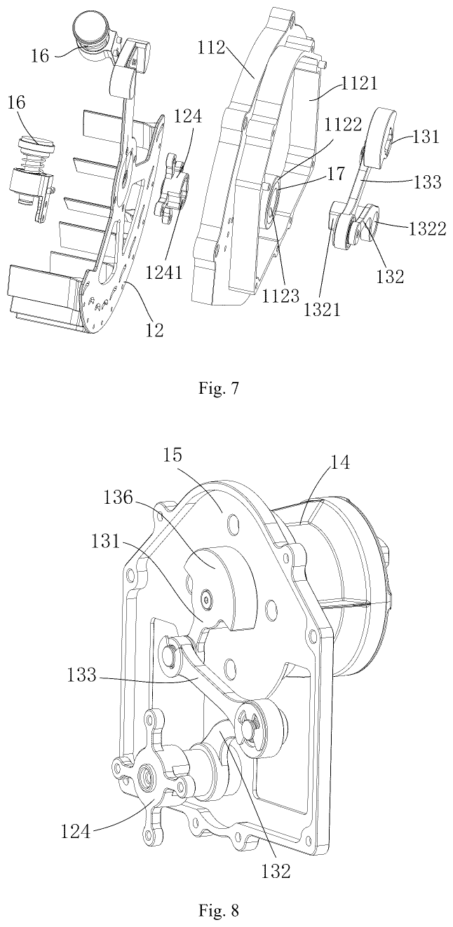

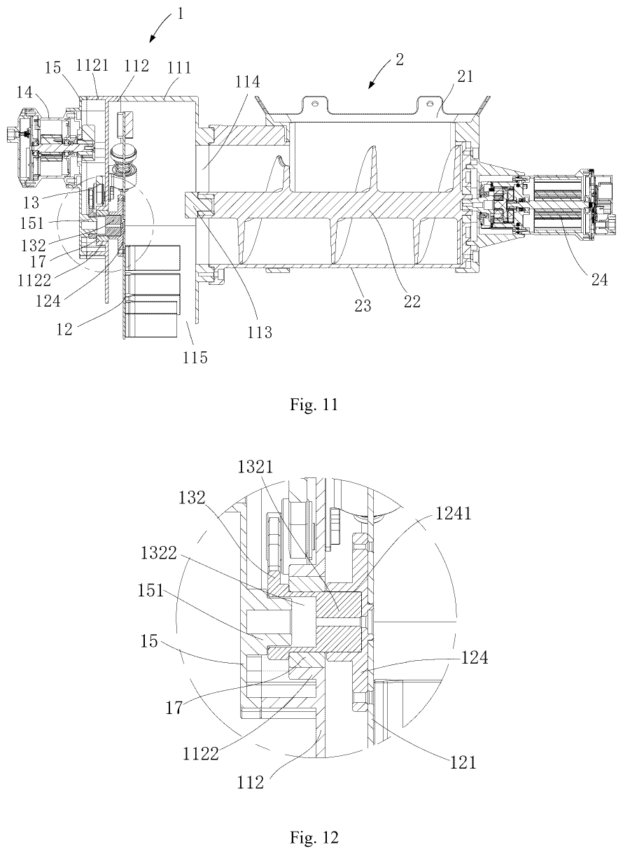

To be specific, as shown in FIGS. 6 and 7 (in conjunction with FIGS. 11 and 12), the connection rod mechanism 13 is arranged outside the installation housing 11. The swing disc 12 is provided with a non-circular hole 1241 at a side facing the connection rod mechanism 13, the second connection rod 132 is provided with a connection shaft 1321, the connection shaft 1321 includes a non-circular member passing through the installation housing 11 and fitted into the non-circular hole 1241, and the second connection rod 132 drives the swing disc 12 to swing through the non-circular member.

Further, the swing disc 12 is provided with a connection flange 124 at a side facing the connection rod mechanism 13, and the connection flange 124 is fixed onto a swing disc body 121 of the swing disc 12 via a bolt. The connection flange 124 is provided with the non-circular hole 1241, one end of the second connection rod 132 away from the intermediate connection rod 133 is provided with the connection shaft 1321, and the non-circular member of the connection shaft 1321 passes through an axle hole 1123 in the second housing 112 and is then inserted into the non-circular hole in the connection flange 123, so that the second connection rod 132 drives, during the swinging, the swing disc 12 to swing through the cooperation of the connection shaft 1321 and the connection flange 124. FIG. 8 shows a state where the connection flange 124 is connected to the second connection rod 132.

The swing disc 12 needs to move back and forth rapidly, so relatively large impact vibration is generated. In some embodiments of the present disclosure, various measures are taken to reduce the vibration.

In some embodiments of the present disclosure, a rotary shaft of at least one of the first connection rod 131, the intermediate connection rod 133 and the second connection rod 132 is mounted into a collar, and a cushion is arranged between the rotary shaft and the collar. Usually, the cushion is made of an elastic rubber material.

As shown in FIGS. 6 and 7, the second housing 112 is provided with a collar 1122 surrounding the axle hole 1123, and the rotary shaft (i.e., the connection shaft 1321) of the second connection rod 132 is inserted into the collar 1122, enters the installation housing 11, and is then connected to the swing disc 12. A first cushion 17 is arranged between the collar 1122 and the connection shaft 1321, so as to reduce the vibration generated in a case that the second connection rod 132 drives the swing disc 12 to swing.

In addition, as shown in FIG. 6, at a pivot joint between the second connection rod 132 and the intermediate connection rod 133, the second connection rod 132 is provided with the rotary shaft at one end connected to the intermediate connection rod 133, the intermediate connection rod 133 is provided with the collar, the rotary shaft is inserted into the collar, and a second cushion 135 is arranged between the rotary shaft and the collar. Through the cushion, it is able to reduce the vibration caused by the swinging. At the other pivot joints, the cushion may also be provided to reduce the vibration.

In some embodiments of the present disclosure, the first connection rod 131 is provided with a balancing weight 136 at one end away from the intermediate connection rod 133, so as to cancel out the vibration caused by the eccentric motion of the first connection rod 131.

In order to reduce the vibration caused by the swinging of the swing disc 12, in some embodiments of the present disclosure, as shown in FIG. 2, the swing disc 12 includes a spreading member (a plurality of blades 122 in FIG. 2) arranged at one side of a swinging center and a block 123 arranged at another side of the swinging center. The installation housing 11 is further provided with buffer assemblies 16 arranged at two sides of the block 123, and the block 123 is a buffer block colliding with the buffer assemblies 16 during the swinging. In addition, the block 123 also serves as a balancing weight. The spreading member is located below the swinging center, and in a case that the balancing weight is arranged at a side of the swing disc 12 away from the spreading member, it is able to move a center of gravity of the swing disc 12 upward, thereby to improve the swinging stability of the swing disc. In other words, in FIG. 2, the block 123 not only serves as a balancing weight for moving the center of gravity of the swing disc 12 upward, but also serves as a buffer block colliding with the buffer assemblies 16. A portion of the buffer assembly 16 colliding with the block 123 is made of a flexible material, e.g., rubber, so the block 123 may be made of a metallic material. Of course, the block 123 may also be made of a flexible material.

As shown in FIG. 5, the buffer assembly 16 includes a buffer member 161, a guiding rod 162, a spring 163 and an installation seat 164. The installation seat 164 is fixed onto the installation housing 11, and the guiding rod 162 moves axially to pass through an installation hole in the installation seat 164. The spring 163 is arranged between the buffer member 161 and the installation seat 164, and the guiding rod 162 is provided with a circlip 165 at one end away from the spring 163, so as to prevent the guiding rod 162 from being detached from the installation seat 164. During the swinging of the swing disc 12, in a case that the block 123 collides with the buffer member 161 of the buffer assembly 16, the buffer member 11 pushes the guiding rod 162 to move, and the spring 163 is compressed, so as to achieve a buffer effect. After the block 123 moves away from the buffer member 161, the buffer member 161 and the guiding rod 162 are reset under the effect of the spring 163.

In an embodiment of the present disclosure, as shown in FIGS. 1 and 2, the swing disc 12 is configured to swing back and forth from one side to another side in a vertical direction, the swing disc 12 includes a spreading member located below a swinging center, and the material outlet 115 is arranged below the installation housing 11. In this way, in a case that the swing disc 12 swings back and forth, the material is spread to the outside by the spreading member via the material outlet 115.

Of course, in addition to swinging back and forth in the vertical direction, the swing disc 12 may also be driven by the swinging drive mechanism to swing back and forth from one side to another side in a horizontal direction or any other direction.

In an embodiment of the present disclosure, as shown in FIGS. 2 and 4, the swing disc 12 includes a swing disc body 121 and a spreading member arranged on the swing disc body 121, the spreading member includes a plurality of blades 122 spaced apart from each other at intervals in a circumferential direction, and a material-passing space is formed between the adjacent blades 122. After the material enters the installation housing 11 via the material inlet 114, it falls onto the blade 122, and is then spread to the outside during the swinging of the swing disc 12.

To be specific, the swing disc body 121 is of a fan-shaped structure, and the plurality of blades 122 is arranged along an arc edge of the swing disc body 121. An angle is formed between an extension direction of each blade 122 and a radial direction of the swing disc body 121, and the angles between different blades 122 and the radial direction are different.

In the embodiments of the present disclosure, the angle is within a range of 14° to 40°, e.g., 14.18°, 22°, 32.76° or 38.87°. In some other embodiments of the present disclosure, the angle may also be 14°, 20°, 33.41° or 40°, which will not be particularly defined herein.

In the embodiments of the present disclosure, the blade 122 has a thickness of 5 mm. The blade 122 is of a rectangular structure, and it has a length of 26 mm in the radial direction of the swing disc body 121.

In an embodiment of the present disclosure, in order to facilitate the installation of the first electric motor 14, an electric motor installation seat 15 for the first electric motor 14 is arranged at a side of the connection rod mechanism 13 away from the installation housing 11, and the electric motor installation seat 15 is fixed onto the installation housing 11.

As shown in FIGS. 1 to 3, an installation frame 1121 is arranged outside the installation housing 11, and the connection rod mechanism 13 is mounted in a space defined by the installation frame 1121. The electric motor installation seat 15 is mounted on the installation frame 1121 and covers the connection rod mechanism 13, so as to protect the connection rod mechanism 13.

To be specific, the electric motor installation seat 15 includes a plate body fastened to the installation frame 1121 in a snap-fit manner, the installation frame 1121 is provided with an installation platform with a plurality of bolt holes, and the plate body is fixed onto the installation platform of the installation frame 1121 through bolts. In this way, the connection rod mechanism 13 is received in a space defined by the installation frame 1121 and the plate body, and the first electric motor 14 is mounted at a side of the plate body away from the connection rod mechanism 13.

Further, as shown in FIG. 6, the first connection rod 131 is provided with a driving shaft 134, and a cross section of the driving shaft 134 is non-circular, so the driving shaft 134 is fitted into the non-circular hole in the first connection rod 131. The first electric motor 14 is connected to the driving shaft 134, so as to drive the first connection rod 131 to rotate circumferentially through the driving shaft 134, thereby to drive the intermediate connection rod 133 to wring. The intermediate connection rod 133 drives the second connection rod 132 to swing, and thereby the second connection rod 132 drives the swing disc 12 to swing.

In addition, as shown in FIG. 2, an abutment block 151 is arranged at a side of the electric motor installation seat 15 facing the connection rod mechanism 13, and configured to abut against the second connection rod 132 at a position where the connection shaft 1321 is provided. To be specific, an insertion hole 1322 is formed in the second connection rod 132 at a position corresponding to the connection shaft 1321, as shown in FIGS. 6, 11 and 12, and the abutment block 151 is inserted into the insertion hole 1322 and abuts against the second connection rod 132, so as to prevent the connection shaft 1321 of the second connection rod 132 from being detached from the swing disc 12.

FIG. 12 (in conjunction with FIG. 7) shows a situation where the connection shaft 1321 of the second connection rod 132 is connected to the swing disc 12. A connection flange 124 is arranged at a side of the swing disc of the swing disc body 121 of the swing disc 12, a non-circular hole 1241 is formed in the connection flange 124, and the connection shaft 1321 of the second connection rod 132 is inserted into the non-circular hole 1241. The abutment bock 151 of the electric motor installation seat 15 includes an insertion member and a protrusion protruding radially from the insertion member. The insertion member is inserted into the insertion hole 1322, and the protrusion abuts against an edge of the insertion hole 1322, so as to ensure the connection between the second connection rod 132 and the swing disc 12.

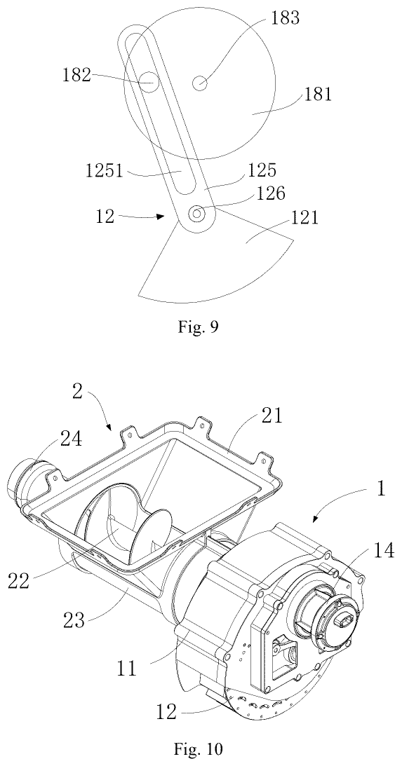

In addition to the connection rod mechanism, there is a plurality of swinging drive mechanisms for driving the swing disc 12 to swing, e.g., a mechanism as shown in FIG. 9, as long as it may drive the swing disc to swing.

As shown in FIG. 9, the swing disc 12 is rotatable, and a guiding slot 1251 is formed in the swing disc 12. The swinging drive mechanism includes a rotatable plate 181 and a bump 182 arranged at a position away from a center of the rotatable plate 181. The bump 182 is located in the guiding slot 1251, and in a case that the rotatable plate 181 rotates, the bump 182 moves in the guiding slot 1251 to drive the swing disc 12 to swing with a rotation center as a swinging center.

More specifically, the swing disc 12 is rotatably mounted on the installation housing 11 through a first rotary shaft 126, the swing disc 12 includes the swing disc body 121 and a connection member 125 connected to the swing disc body 121, and the guiding slot 1251 is formed in the connection member 125. The connection member 125 is fixedly connected to the swing disc body 121 at the first rotary shaft 126. The rotatable plate 181 is rotatably mounted on the installation housing 11 through a second rotary shaft 183, and the rotatable plate 181 rotates under the effect of an electric motor, so as to drive the bump 182 to move along the guiding slot 1251. Through the cooperation of the bump 182 and the guiding slot 1251, the swing disc 12 is driven to swing.

A plurality of blades may also be arranged on the swing disc body 121, as shown in FIG. 4, so as to spread the material to the outside during the swinging of the swing disc 12.

The present disclosure further provides in some embodiments a spreading device which, as shown in FIGS. 10 to 14, includes the above-mentioned swing disc spreader 1 and a feeding mechanism 2 for supplying a material to the swing disc spreader 1.

In an embodiment of the present disclosure, the material inlet 114 of the swing disc spreader 1 is arranged at one side of the installation housing 11, and the feeding mechanism 2 is connected to the side of the installation housing having the material inlet 114 so as to supply the material to the material inlet 114.

In an embodiment of the present disclosure, the feeding mechanism 2 includes a main frame 21 with a feeding inlet and a material guiding assembly mounted on the main frame 21, the material guiding assembly is configured to deliver the material in the main frame to the material inlet 114 of the installation housing 11, and the material guiding assembly includes an auger 22 and a second electric motor 24 for driving the auger 22.

In a possible embodiment of the present disclosure, in order to facilitate the pick-and-place of the auger 22 as a whole, the material guiding assembly further includes a sleeve 23 with an opening 231, the auger 22 is mounted in the sleeve 23, and then the sleeve 23 and the auger are mounted on the main frame 21 as a whole. The opening 231 of the sleeve 23 is in communication with the feeding inlet of the main frame, and the material entering the main frame via the feeding inlet enters the sleeve 23 via the opening 231, and then is delivered by the auger 22 to the swing disc spreader 1.

To be specific, as shown in FIG. 2, an auger installation member 113 is arranged at the material inlet 114 of the installation housing 11 of the swing disc spreader 1, one end of the auger 22 is rotatably mounted on the auger installation member 113, and one end of the sleeve 23 is aligned with the material inlet 114 of the installation housing 11. Another end of the auger 22 is connected to the second electric motor 24, so that the second electric motor 24 drives the auger 22 to rotate.

During the spreading of the material, the material enters the main frame 21 via the feeding inlet of the main frame 21, and is delivered by the auger 22 to the installation housing 11 of the swing disc spreader 1, and is then spread to the outside during the swinging of the swing disc 12.

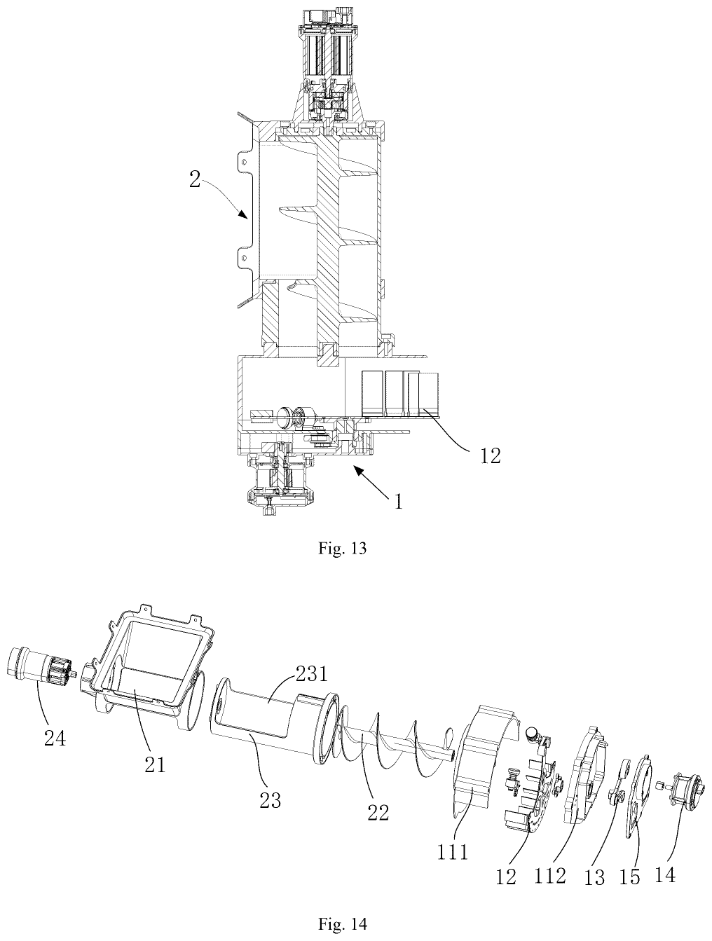

For the swing disc spreader 1, an angle between a swinging plane of the swing disc 12 and a horizontal plane is 0° to 90°. To be specific, during the spreading, in a case that the angle between the swinging plane of the swing disc 12 and the horizontal plane is 0°, the swing disc 12 swings in the horizontal plane. In a case that the angle between the swinging plane of the swing disc 12 and the horizontal plane is 90°, the swing disc 12 swings in a vertical plane. In a case that the angle between the swinging plane of the swing disc 12 and the horizontal plane is greater than 0° and smaller than 90°, the swing disc 12 swings in an oblique plane between the vertical plane and the horizontal plane. As shown in FIG. 11, the swing disc swings in the vertical plane, and as shown in FIG. 13, the swing disc 12 swings in the horizontal plane. The swinging plane of the swing disc 12 is implemented through installing the swing disc spreader in the spreading device, or through installing the spreading device on an unmanned aerial vehicle or the like.

To be specific, the swinging plane of the swing disc 12 is perpendicular to a reference plane, and swinging amplitudes of the swing disc 12 at two sides of the reference plane are the same.

In the embodiments of the present disclosure, the reference plane is parallel to the vertical direction.

The present disclosure further provides in some embodiments an unmanned aerial vehicle which includes the above-mentioned spreading device. During the operation of the spreading device, the feeding mechanism 2 supplies a material to the swing disc spreader 1, and the swinging drive mechanism of the swing disc spreader 1 drives the swing disc 12 to swing back and forth. The swing disc 12 is in contact with the material during the swinging, so as to spread the material to the outside. As compared with the related art where two spreading assemblies are arranged side by side, in the embodiments of the present disclosure, the swing disc spreader 1 spreads the material through merely one swing disc 12, so it is able to simplify the structure, reduce the overall volume, provide a uniform sowing width, and reduce the cost. A swinging plane of the swing disc 12 is parallel to a yaw axis or a roll axis of the unmanned aerial vehicle.

Agricultural unmanned aerial vehicles have developed rapidly, and their payload increases gradually, so they have been applied to field agricultural production. For the management of field crops, the unmanned aerial vehicle is used to not only spray liquid farm chemicals, but also spread particles such as seeds, powders and solid fertilizers. In order to achieve this purpose, the unmanned aerial vehicle is equipped with a spreading device.

For a conventional spreading device, the material easily enters a transmission member during the spreading, so the operation of the transmission member is adversely affected.

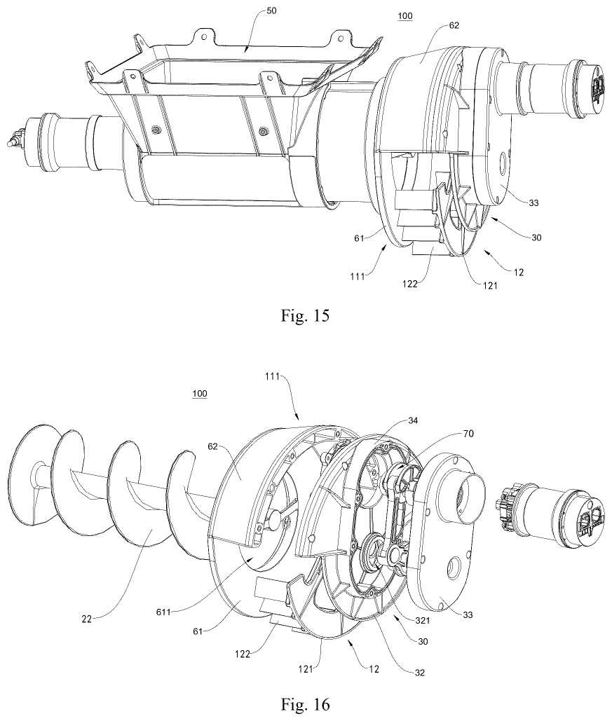

As shown in FIGS. 15 and 16, the present disclosure further provides in some embodiments an unmanned aerial vehicle, which includes a spreading device 100 and a vehicle body. The spreading device 100 is arranged at a bottom of the vehicle body, and configured to perform a spreading operation during the flight of the unmanned aerial vehicle. According to the unmanned aerial vehicle in the embodiments of the present disclosure, it is able to prevent the material from entering a transmission member 70, and ensure the normal operation of the transmission member 70, thereby to ensure the normal spreading operation of the spreading device 100.

In the embodiments of the present disclosure, a carrier is the unmanned aerial vehicle, specifically an agricultural unmanned aerial vehicle which is usually equipped with a spraying assembly and a sowing assembly for spraying, watering and sowing. Of course, the carrier may also be equipped with a camera or a game device. In addition, apart from the unmanned aerial vehicle, the carrier may also be a robot, an unmanned vehicle, an unmanned ship, etc.

The present disclosure further provides in some embodiments a spreading device 100. A swinging drive mechanism includes a transmission member 70 connected to a swing disc 12 and configured to drive the swing disc 12 to move. The spreading device 100 further includes a separator 30 arranged between the swing disc 12 and the transmission member 70 and configured to prevent a material from entering the transmission member 70.

As shown in FIG. 15, the present disclosure provides in some embodiments a spreading device 100, which includes a swing disc 12, a transmission member 70 and a separator 30. The swing disc 12 is configured to spread a material, the transmission member 70 is connected to the swing disc 12 and configured to drive the swing disc 12 to move, and the separator 30 is arranged between the swing disc 12 and the transmission member 70 and configured to prevent the material from entering the transmission member 70. The swing disc 12 swings back and forth relative to the separator 30, so as to spread the material.

To be specific, in the related art, during the operation of the spreading device 100, the material in a material box 50 is delivered to the swing disc 12 to be in contact with the blade 122 of the swing disc 12, and the transmission member 70 drives the swing disc 12 to move, so as to spread the material to the outside. The material in the swing disc 12 easily enters the transmission member 70, so the normal operation of the transmission member 70 is adversely affected. In order to solve this problem, in the embodiments of the present disclosure, during the operation of the spreading device 100, the swing disc 12 is connected to the transmission member 70, and the transmission member 70 drives the swing disc 12 to move, so as to spread the material to the outside. The separator 30 is arranged between the swing disc 12 and the transmission member 70, so as to prevent the material from entering the transmission member 70. Through the separator 30, it is able to ensure the normal operation of the transmission member 70, thereby to ensure the normal spreading operation of the spreading device 100.

In some embodiments of the present disclosure, the above-mentioned second housing 112 serves as the separator 30.

In the embodiments of the present disclosure, the separator 30 includes a baffle 32, and the swing disc 12 and the transmission member 70 are arranged at two sides of the baffle 32 respectively. Through the baffle 32, it is able to directly prevent the material from entering the transmission member 70, and ensure that all the material enters the swing disc 12, thereby to further improve the spreading efficiency.

To be specific, the baffle 32 is a circular or elliptical plate.

It should be appreciated that, the swing disc 12 is driven by the transmission member 70 to swing relative to the baffle 32 back and forth, so as to spread the material to the outside.

It should be appreciated that, the swing disc 12 includes the swing disc body 121 and the plurality of blades 122, and the plurality of blades 122 is arranged on the swing disc body 121 at intervals in a circumferential direction. The swing disc body 121 swings, so as to enable the blade 122 to be in contact with the material, thereby to spread the material to the outside.

To be specific, the baffle 32 is provided with a connection hole 321, and the transmission member 70 is connected to the swing disc body 121 via the connection hole 321. An output end of the transmission member 70 is connected to the swing disc body 121 via the connection hole 321, so that the transmission member 70 drives the swing disc body 121 to swing back and forth. A size of the connection hole 321 matches with a size of the output end of the transmission member 70.

In the embodiments of the present disclosure, the connection hole 321 is a circular hole. In some other embodiments of the present disclosure, the connection hole 321 is an elliptical or square hole, which will not be particularly defined herein.

In order to prevent the material from entering the transmission member 70 via the connection hole 321 and ensure the normal operation of the transmission member 70, the spreading device 100 includes a sealing element arranged in the connection hole 31.

In an embodiment of the present disclosure, the sealing element is a sealing ring arranged in the connection hole 321.

The separator 30 further includes a cover plate 33 arranged at a side of the baffle 32 away from the swing disc 12 and configured to cover the transmission member 70. To be specific, an annular plate 34 is arranged on the baffle 32 at a side away from the swing disc 12, the annular plate 34 is detachably connected to the cover plate 33, an accommodation cavity is defined by the annular plate 34 and the cover plate 33, and the transmission member 70 is arranged in the accommodation cavity. A sealing cavity is defined by an arc-like plate 62 and the cover plate 33, so as to seal the transmission member 70, and prevent the transmission member 70 from operating abnormally.

It should be appreciated that, the spreading device 100 further includes a first electric motor arranged at a side of the cover plate 33 away from the transmission member 70, connected to the transmission member 70, and configured to drive the transmission member 70 to move, so that the transmission member 70 drives the swing disc 12 to swing back and forth.

In some embodiments of the present disclosure, the spreading device 100 further includes a first housing 111 arranged at a side of the separator 30 close to the swing disc 12 and configured to cover the swing disc 12. To be specific, the first housing 111 includes a side plate 61 and an arc-like plate 62 arranged at a side of the side plate 61 close to the swing disc 12, the arc-like plate 62 is connected to an upper edge of the side plate 61 and the baffle 32, the side plate 61 is spaced apart from the baffle 32 through the arc-like plate 62, and the swing disc 12 is arranged between the side plate 61 and the baffle 32.

To be specific, the side plate 61 is a circular plate, and an arc length of the arc-like plate 62 is smaller than half a perimeter of the side plate 61. The arc-like plate 62 is arranged above the side plate 61 and covers the swing disc 12, and two ends of the arc-like plate 62 are connected to the side plate 61 and the baffle 32 respectively.

It should be appreciated that, the spreading device 100 further includes an auger 22 and a material box 50. The material box 50 is arranged at a bottom of the vehicle body, the auger 22 is arranged at a material outlet of the material box 50, the material box 50 is configured to receive the material, and one end of the auger 22 is connected to the side plate 61. The side plate 61 is provided with a through-hole 611, and one end of the auger 22 is arranged in the through-hole 611. The material in the material box 50 enters the auger 22 via the material outlet, and is delivered to the through-hole 611 in a case that the auger 22 rotates. Then, the material enters the swing disc 12 via the through-hole 611 to be in contact with the blades 22 of the swing disc 12, so as to be spread to the outside.

The spreading device 100 and the unmanned aerial vehicle provided in the embodiments of the present disclosure at least have the following advantages.

During the operation of the conventional spreading device 100, the material in the material box 50 is delivered to the swing disc 12 to be in contact with the blades 122 of the swing disc 12, and the transmission member 70 drives the swing disc 12 to move, so as to spread the material to the outside. The material easily enters the transmission member 70, so the normal operation of the transmission member 70 is adversely affected. In order to solve this problem, in the embodiments of the present disclosure, during the operation of the spreading device 100, the swing disc 12 is connected to the transmission member 70, and the transmission member 70 drives the swing disc 12 to move, so as to spread the material to the outside. The separator 30 is arranged between the swing disc 12 and the transmission member 70, so as to prevent the material from entering the transmission member 70, and ensure the normal operation of the transmission member 70, thereby to ensure the normal spreading operation of the spreading device 100.

In a word, according to the embodiments of the present disclosure, the spreading device 100 includes the swing disc 12, the transmission member 70 and the separator 30. The swing disc 12 is configured to spread the material, the transmission member 70 is connected to the swing disc 12 and configured to drive the swing disc 12 to move, and the separator 30 is arranged between the swing disc 12 and the transmission member 70 to prevent the material from entering the transmission member 70. During the operation of the spreading device 100, the swing disc 12 is connected to the transmission member 70, and the transmission member 70 drives the swing disc 12 to move, so as to spread the material to the outside. The separator 30 arranged between the swing disc 12 and the transmission member 70 is used to prevent the material from entering the transmission member 70, and ensure the normal operation of the transmission member 70, thereby to ensure the normal spreading operation of the spreading device 100.

The unmanned aerial vehicle includes the vehicle body and the spreading device 100 arranged at a bottom of the vehicle body. During the operation of the unmanned aerial vehicle, the swing disc 12 is connected to the transmission member 70, and the transmission member 70 drives the swing disc 12 to move, so as to spread the material to the outside. The separator 30 arranged between the swing disc 12 and the transmission member 70 is used to prevent the material from entering the transmission member 70, and ensure the normal operation of the transmission member 70, thereby to ensure the normal spreading operation of the spreading device 100.

The above are merely the preferred embodiments of the present disclosure, but shall not be construed as limiting the scope of the present disclosure. Any person skilled in the art may make modifications and substitutions without departing from the spirit of the present disclosure, and these modifications and substitutions shall also fall within the scope of the present disclosure. Hence, the scope of the present disclosure shall be subject to the scope defined by the appended claims.

What is claimed is:

1. A swing disc spreader, comprising:
a rotatable swing disc; and
a swinging drive mechanism in transmission connection with the swing disc and configured to drive the swing disc to swing back and forth,
wherein the swing disc is in contact with a material during swinging to spread the material to the outside.

2. The swing disc spreader according to claim 1, further comprising an installation housing, wherein the installation housing is provided with a material inlet and a material outlet, and the swing disc is rotatably mounted inside the installation housing; and
the material entering the installation housing via the material inlet is spread to the outside via the material outlet in a case that the swing disc swings.

3. The swing disc spreader according to claim 2, wherein the swinging drive mechanism comprises a first electric motor and a connection rod mechanism, the first electric motor is configured to drive the connection rod mechanism to move, and the connection rod mechanism is configured to drive the swing disc to swing.

4. The swing disc spreader according to claim 3, wherein the connection rod mechanism is arranged outside the installation housing, and the connection rod mechanism is connected to the swing disc via an installation hole in the installation housing;
the installation housing comprises a first housing and a second housing, and the first housing is fastened to the second housing to form an accommodation space for receiving the swing disc; and
the first housing is provided with the material inlet, the swing disc is mounted on the second housing, and the connection rod mechanism is mounted on a side of the second housing away from the swing disc.

5. The swing disc spreader according to claim 3, wherein the connection rod mechanism comprises a first connection rod, a second connection rod and an intermediate connection rod; and
the first connection rod is configured to rotate under the effect of the first electric motor, the second connection rod is connected to the swing disc and limited relative to the swing disc in a circumferential direction, one end of the intermediate connection rod is rotatably connected to the first connection rod, another end of the intermediate connection rod is rotatably connected to the second connection rod, and the first connection rod rotates to drive the second connection rod to swing through the intermediate connection rod, so that the second connection rod drives the swing disc to swing back and forth.

6. The swing disc spreader according to claim 5, wherein the connection rod mechanism is arranged outside the installation housing; and
the swing disc is provided with a non-circular hole at a side facing the connection rod mechanism, the second connection rod is provided with a connection shaft, the connection shaft comprises a non-circular member passing through the installation housing and fitted into the non-circular hole, and the second connection rod drives the swing disc to swing through the non-circular member.

7. The swing disc spreader according to claim 5, wherein the first connection rod is provided with a balancing weight at an end away from the intermediate connection rod; and/or
a rotary shaft of at least one of the first connection rod, the intermediate connection rod and the second connection rod is mounted into a collar, and a cushion is arranged between the rotary shaft and the collar.

8. The swing disc spreader according to claim 1, wherein the swing disc is configured to swing back and forth from one side to another side in a vertical direction, and the swing disc comprises a spreading member located below a swinging center of the swing disc.

9. The swing disc spreader according to claim 1, wherein the swing disc comprises a swing disc body and a spreading member arranged on the swing disc body, the spreading member comprises a plurality of blades spaced apart from each other at intervals in a circumferential direction, and a material-passing space is formed between the adjacent blades.

10. The swing disc spreader according to claim 2, wherein the swing disc comprises a spreading member arranged at one side of a swinging center and a block arranged at another side of the swinging center; and
the block is a balancing weight; and/or the block is a buffer block colliding with buffer assemblies, and the buffer assemblies are mounted on the installation housing and arranged at two sides of the block.

11. The swing disc spreader according to claim 1, wherein the swing disc is rotatable, and a guiding slot is formed in the swing disc; and
the swinging drive mechanism comprises a rotatable plate and a bump arranged at a position away from a center of the rotatable plate, the bump is located in the guiding slot, and in a case that the rotatable plate rotates, the bump moves in the guiding slot to drive the swing disc to swing with a rotation center as a swinging center.

12. The swing disc spreader according to claim 9, wherein an angle is formed between an extension direction of each blade and a radial direction of the swing disc body, and the angles between different blades and the radial direction are different.

13. A spreading device, comprising the swing disc spreader according to claim 1 and a feeding mechanism for supplying a material to the swing disc spreader.

14. The spreading device according to claim 13, wherein the feeding mechanism comprises a main frame with a feeding inlet and a material guiding assembly mounted on the main frame, the material guiding assembly is configured to deliver the material in the main frame to the material inlet of the swing disc spreader, and the material guiding assembly comprises an auger and a second electric motor for driving the auger.

15. The spreading device according to claim 13, wherein the swinging drive mechanism comprises a transmission member connected to the swing disc and configured to drive the swing disc to move; and
the spreading device further comprises a separator arranged between the swing disc and the transmission member and configured to prevent the material from entering the transmission member.

16. The spreading device according to claim 15, wherein the separator comprises a baffle, and the swing disc and the transmission member are arranged at two sides of the baffle respectively.

17. The spreading device according to claim 16, wherein the baffle is provided with a connection hole, and the transmission member is connected to the swing disc via the connection hole; and
the spreading device comprises a sealing element arranged in the connection hole.

18. The spreading device according to claim 16, wherein the separator further comprises a cover plate arranged at a side of the baffle away from the swing disc and configured to cover the transmission member; and
an annular plate is arranged on the baffle at a side away from the swing disc, the annular plate is detachably connected to the cover plate, an accommodation cavity is defined by the annular plate and the cover plate, and the transmission member is arranged in the accommodation cavity.

19. The spreading device according to claim 16, further comprising a first housing arranged at a side of the separator close to the swing disc and configured to cover the swing disc,
wherein the first housing comprises a side plate and an arc-like plate arranged at a side of the side plate close to the swing disc, the arc-like plate is connected to an upper edge of the side plate and the baffle, the side plate is spaced apart from the baffle through the arc-like plate, and the swing disc is arranged between the side plate and the baffle.

20. An unmanned aerial vehicle comprising the spreading device according to claim 13.
